(19) United States
(12) Patent Application Publication
(10) Pub. No.: US 2026/0178156 A1
(43) Pub. Date: Jun. 25, 2026

(54) ABNORMALITY DETECTION BY FORCE SENSING

(71) Applicant: Lenovo (Beijing) Limited, Beijing (CN)

(72) Inventors: XinMei Yang, Kanagawa (JP); Junrong Zhou, Beijing (CN)

(73) Assignee: Lenovo (Beijing) Limited, Beijing (CN)

(21) Appl. No.: 18/844,504

(22) PCT Filed: Oct. 25, 2023
(86) PCT No.: PCT/CN2023/126459

§ 371 Date: Sep. 6, 2024

(51) Int. Cl. G06F 3/044

(52) U.S. Cl. CPC G06F 3/0446; G06F 3/044

(57) ABSTRACT

A computing system includes a sensing system and a processor. The sensing system includes a touch sensor configured to detect touch of an input object in a dedicated sensing region; and a force sensor configured to detect force applied to the sensing system. The processor is configured to determine abnormality based on detection results from the touch sensor and the force sensor.

### BACKGROUND

An abnormality may occur in a computing system, potentially causing damage to components in the computing system, such as a sensing system, or even danger to the user. The cause of the abnormality may be an obstruction that falls inside the computing system during assembly or a misfunction of components. For example, an obstruction in between the sensing system and its neighboring component or a bulging battery disposed in proximity to the sensing system may apply a force, or even puncture, the sensing system and/or its neighboring component. Accordingly, there exists a need to detect when such an abnormality occurs.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In some aspects, the techniques described herein relate to a computing system including: a sensing system including: a touch sensor configured to detect touch of an input object in a dedicated sensing region; and a force sensor configured to detect force applied to the sensing system; and a processor configured to determine abnormality based on detection results from the touch sensor and the force sensor.

In some aspects, the techniques described herein relate to a computing system, wherein the force sensor includes a first capacitive sensing plate and a second capacitive sensing plate, and the force is detected based on a distance between the first capacitive sensing plate and the second capacitive sensing plate.

In some aspects, the techniques described herein relate to a computing system, wherein the force sensor includes a plurality of force sensing units, each including a first capacitive sensing plate and a second capacitive sensing plate.

In some aspects, the techniques described herein relate to a computing system, wherein the plurality of force sensing units each detect a sensed force, and the processor determines a position of the abnormality based on the sensed forces detected by the plurality of force sensing units.

In some aspects, the techniques described herein relate to a computing system, wherein the touch sensor includes a touch layer, a baseplate, and a spacer layer between the touch layer and the baseplate, the force sensor includes a first capacitive sensing plate coupled to the touch layer and a second capacitive sensing plate coupled to the baseplate, and the first capacitive sensing plate and the second capacitive sensing plate face each other and are spaced apart at a distance.

In some aspects, the techniques described herein relate to a computing system 1-5, wherein the processor is configured to compare the force detected by the force sensor to a predetermined base value.

In some aspects, the techniques described herein relate to a computing system 1-6, wherein the computing system performs a normal start, when the force detected by the force sensor is substantially same to a predetermined base value.

In some aspects, the techniques described herein relate to a computing system 1-7, wherein the computing system is configured to generate an alert message when the force detected by the force sensor is different from a predetermined base value and the touch of the input object is not detected by the touch sensor.

In some aspects, the techniques described herein relate to a computing system 1-8, wherein the computing system is configured to request the input object to be removed, when the force detected by the force sensor is different from a predetermined base value and the touch of the input object is detected by the touch sensor.

In some aspects, the techniques described herein relate to a method including: activating a computing system; detecting whether force is applied to a sensing system in the computing system, using a force sensor in the sensing system; detecting whether touch of an input object occurred in a dedicated sensing region, using a touch sensor in the sensing system; and determining abnormality based on detection results from the touch sensor and the force sensor.

In some aspects, the techniques described herein relate to a method, further including comparing the force detected by the force sensor to a predetermined base value.

In some aspects, the techniques described herein relate to a method, further including performing a normal start to the computing system, when the force detected by the force sensor is substantially same to a predetermined base value.

In some aspects, the techniques described herein relate to a method, further including generating an alert message when the force detected by the force sensor is different from a predetermined base value and the touch of the input object is not detected by the touch sensor.

In some aspects, the techniques described herein relate to a method, further including requesting the input object to be removed, when the force detected by the force sensor is different from a predetermined base value and the touch of the input object is detected by the touch sensor.

In some aspects, the techniques described herein relate to a method, further including determining a position of the abnormality based on sensed forces detected by a plurality of force sensing units in the force sensor, each of the force sensing units including a first capacitive sensing plate and a second capacitive sensing plate.

Other aspects and advantages of the claimed subject matter will be apparent from the following description and the appended claims.

### BRIEF DESCRIPTION OF DRAWINGS

FIG. 1 shows a block diagram of a computing system in accordance with one or more embodiments of the disclosure.

FIG. 2 shows a scheme of a force sensor in accordance with one or more embodiments of the disclosure.

FIG. 3 shows a flowchart for a method of abnormality detection in accordance with one or more embodiments of the disclosure.

### DETAILED DESCRIPTION

Specific embodiments of the present disclosure will now be described in detail below with reference to the accompanying drawings. Like elements in the various figures are denoted by like reference numerals for consistency.

In the following detailed description of embodiments of the disclosure, numerous specific details are set forth to provide a more thorough understanding of the invention. However, it will be apparent to one of ordinary skill in the art that the invention may be practiced without these specific details. In other instances, well-known features have not been described in detail to avoid unnecessarily complicating the description.

Throughout the application, ordinal numbers (e.g., first, second, third) may be used as an adjective for an element (e.g., any noun in the application). The use of ordinal numbers is not intended to imply or create a particular ordering of the elements nor to limit any element to being only a single element unless expressly disclosed, such as using the terms “before,” “after,” “single,” and other such terminology. Rather the use of ordinal numbers is to distinguish between the elements. By way of an example, a first element is distinct from a second element, and the first element may encompass more than one element and may succeed (or precede) the second element in an ordering of elements.

Various embodiments of the present disclosure provide systems and methods for abnormality detection utilizing force sensing.

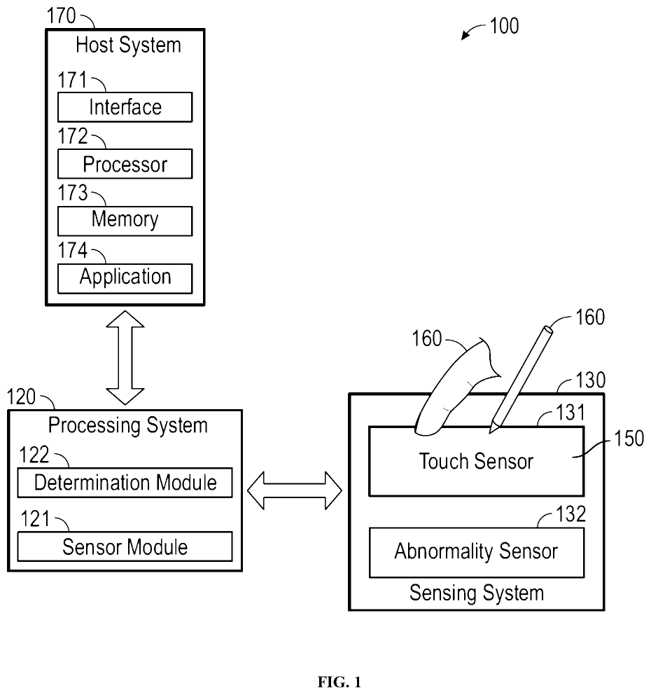

Turning now to the figures, FIG. 1 is a block diagram of a computing system 100 in accordance with one or more embodiments of the present disclosure. The computing system 100 is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. The computing system 100 can serve in a role as a client, network component, a server, a database or other persistency, or any other component (or a combination of roles) of a computer for performing the subject matter described in the present disclosure. The computing system 100 may be communicatively coupled with a network, internally or externally. In some implementations, one or more components of the computing system 100 may be configured to operate within environments, including cloud-computing-based, local, global, or other environment (or a combination of environments).

At a high level, the computing system 100 is an electronic device operable to receive, transmit, process, store, or manage data and information associated with the described subject matter. Non-limiting examples of the computing system may include personal computers of all sizes and shapes, such as desktop computers, laptop computers, netbook computers, tablets, web browsers, e-book readers, remote terminals, kiosks, and video game machines, and personal digital assistants (PDAs).

According to one or more embodiments shown in FIG. 1, the computing system 100 includes a sensing system 130, a processing system 120, and a host system 170. The sensing system 130 may be configured to sense a user input by touch and a force applied to the sensing system 130. The processing system 120 may be configured to operate the hardware of the sensing system 130.

The host system 170 may include various elements of the computing system 100, such as interface 171, processor 172, memory 173, and application 174. The interface 171 is used by the computing system 100 for communicating with other systems in a distributed environment, for example, in a network. Generally, the interface 171 includes software supporting one or more communication protocols such that the interface's hardware is operable to communicate physical signals within and outside of the computing system.

The processor 172 may execute instructions and manipulate data to perform the operations of the computing system 100 and any algorithms, methods, functions, processes, flows, and procedures as described in the present disclosure. The processor 172 may include a central processing unit (CPU), one or more cores or micro-cores of a processor, etc. Further, one or more elements of one or more embodiments may be located at a remote location and connected to the other elements over network.

The memory 173 holds data for components in the computing system 100 or other components that are communicatively connected to the computing system 100. The memory 173 may include a non-transitory electronically readable media such as various discs, physical memory, memory, memory sticks, memory cards, memory modules, and/or any other computer readable storage medium. Electronically readable media may be based on flash, optical, magnetic, holographic, or any other storage technology. The application is an algorithmic software engine providing functionality according to particular needs, desires, or particular implementations of the computing system 100, particularly with respect to functionality described in the present disclosure.

The sensing system 130 may be implemented as a physical part of the host system 170 (e.g., a touchpad integrated in the body of a laptop) or may be physically separate from the host system 170 (e.g., an external touch device that is integrated in a keyboard, separate from the host system 170). The processing system 120 may communicate with the host system 170 using any one or more of the following: buses, networks, and other wired or wireless interconnections. Examples include I2C, SPI, PS/2, Universal Serial Bus (USB), Bluetooth, RF, and IRDA.

The sensing system 130 may include a touch sensor 131, configured to sense a user input of an input object 160 in a dedicated sensing region 150, and an abnormality sensor 132, configured to sense a force applied to the sensing system 130.

The input object 160 may be a finger or a stylus, as shown in FIG. 1, or any other object that may be detected in the dedicated sensing region 150. Although a singular form of input object is used, multiple input objects may exist in the dedicated sensing region 150.

The dedicated sensing region 150 encompasses any space, above, around, in and/or near the touch sensor 131 that is exposed to the input object 160, in which the touch sensor 131 is able to detect the user input. The sizes, shapes, and locations of particular sensing regions may vary widely from embodiment to embodiment. In one or more embodiments, the dedicated sensing region 150 extends from a surface of the touch sensor 131 in one or more directions into space until signal-to-noise ratios prevent sufficiently accurate object detection.

The extension above the surface of the touch sensor 131 may be referred to as the above surface sensing region. The distance to which this dedicated sensing region 150 extends in a particular direction, in various embodiments, may be on the order of less than a millimeter, millimeters, centimeters, or more, and may vary significantly with the type of sensing technology used and the accuracy desired. Accordingly, sensing of the user input may be performed with no contact with any surfaces of the touch sensor 131, contact with a touch surface of the touch sensor 131, contact with a touch surface of the touch sensor 131 coupled with some amount of applied force or pressure, or a combination thereof. In various embodiments, the touch surface may be provided by a surface of casings within which the sensor electrodes reside, by face sheets applied over the sensor electrodes or any casings. In one or more embodiments, the dedicated sensing region 150 has a rectangular shape when projected onto the touch surface of the touch sensor 131.

The touch sensor 131 may utilize any combination of commonly known sensor components and sensing technologies and may include one or more sensing elements for detecting a touch. As several non-limiting examples, the touch sensor 131 may use capacitive, elastic, resistive, inductive, magnetic, acoustic, ultrasonic, piezoelectric, strain gauge-based, or optical techniques.

In one or more embodiments, the touch sensor 131 has an inductive configuration, in which one or more sensing elements pick up loop currents induced by a resonating coil or pair of coils. Some combination of the magnitude, phase, and frequency of the currents may then be used to determine positional information.

In one or more embodiments, the touch sensor 131 has a resistive configuration, in which a flexible and conductive first layer is separated by one or more spacer elements from a conductive second layer. During operation, one or more voltage gradients are created across the layers. Pressing the flexible first layer may deflect it sufficiently to create electrical contact between the layers, resulting in voltage outputs reflective of the point(s) of contact between the layers. These voltage outputs may be used to determine positional information.

In one or more embodiments, the touch sensor 131 has a capacitive configuration. Voltage or current may be applied to create an electric field. Nearby input object 160 may cause changes in the electric field and produce detectable changes in capacitive coupling that may be detected as changes in voltage, current, or the like. The presence of a touch may thus be detected in this implementation establishing a touch sensor. In some capacitive implementations, an elastic element may be included between sensing electrodes. In one or more embodiments, the touch sensor 131 has a configuration utilizing arrays or other regular or irregular patterns of capacitive sensing elements to create electric fields. Such arrays may be scanned to obtain touch information from many locations across the dedicated sensing region 150. In some capacitive implementations, separate sensing elements may be ohmically shorted together to form larger sensor electrodes. Some capacitive implementations utilize resistive sheets, which may be uniformly resistive.

The touch sensor 131 may utilize “self-capacitance” (or “absolute capacitance”) sensing methods based on changes in the capacitive coupling between sensor electrodes and an input object. In various embodiments, an input object near the sensor electrodes alters the electric field near the sensor electrodes, thus changing the measured capacitive coupling. In one implementation, an absolute capacitance sensing method operates by modulating sensor electrodes with respect to a reference voltage (e.g., system ground), and by detecting the capacitive coupling between the sensor electrodes and the input object. The reference voltage may be a substantially constant voltage or a varying voltage and in various embodiments; the reference voltage may be system ground. Measurements acquired using absolute capacitance sensing methods may be referred to as absolute capacitive measurements.

The touch sensor 131 may utilize “mutual capacitance” (or “trans capacitance”) sensing methods based on changes in the capacitive coupling between sensor electrodes. In various embodiments, an input object near the sensor electrodes alters the electric field between the sensor electrodes, thus changing the measured capacitive coupling. In one implementation, a mutual capacitance sensing method operates by detecting the capacitive coupling between one or more transmitter sensor electrodes (also “transmitter electrodes” or “transmitter”) and one or more receiver sensor electrodes (also “receiver electrodes” or “receiver”). Transmitter sensor electrodes may be modulated relative to a reference voltage (e.g., system ground) to transmit transmitter signals. Receiver sensor electrodes may be held substantially constant relative to the reference voltage to facilitate receipt of resulting signals. The reference voltage may be a substantially constant voltage, and in various embodiments the reference voltage may be system ground.

In some embodiments, transmitter sensor electrodes and receiver sensor electrodes may both be modulated. The transmitter electrodes are modulated relative to the receiver electrodes to transmit transmitter signals and to facilitate receipt of resulting signals. A resulting signal may include effect(s) corresponding to one or more transmitter signals, and/or to one or more sources of environmental interference (e.g., other electromagnetic signals). The effect(s) may be the transmitter signal, a change in the transmitter signal caused by the input object and/or environmental interference, or other such effects. Sensor electrodes may be dedicated transmitters or receivers or may be configured to both transmit and receive. Measurements acquired using mutual capacitance sensing methods may be referred to as mutual capacitance measurements.

The sensor electrodes may be of varying shapes and/or sizes. The same shapes and/or sizes of sensor electrodes may or may not be in the same groups. For example, in some embodiments, receiver electrodes may be of the same shapes and/or sizes while, in other embodiments, receiver electrodes may be of varying shapes and/or sizes.

The abnormality sensor 132 is configured to sense a force applied to the sensing system. In one or more embodiments, the abnormality sensor 132 may include one or more abnormality sensing units. Each abnormality sensing unit may have a capacitive configuration and comprise a first capacitive sensing plate and a second capacitive sensing plate, facing each other and spaced apart at a defined distance. Abnormality of components in the computing device may cause a change in the distance between the capacitive sensing plates. Thus, the presence of a force, causing the abnormality, may be detected in such an implementation. For example, when the force is applied, as the distance between the capacitive sensing plates decreases, the capacitive sensing plates move closer to one another, and the capacitance measured between the capacitive sensing plates may increase. Accordingly, such a change in capacitance may be correlated to the force that causes the change in the distance. The capacitive sensing plates may be of varying sizes and/or shapes. The same shapes and/or sizes of capacitive sensing plates may or may not be in the same groups. A number of abnormality sensing units may also vary as needed.

Continuing with FIG. 1, the processing system 120 is configured to operate the hardware of the sensing system 130. For example, the processing system 120 includes parts of, or all of, one or more integrated circuits (ICs) and/or other circuitry components. In one or more embodiments, a processing system for a mutual capacitance sensor device may include transmitter circuitry configured to transmit signals with transmitter sensor electrodes, and/or receiver circuitry configured to receive signals with receiver sensor electrodes. In one or more embodiments, a processing system for an absolute capacitance sensor device may include driver circuitry configured to drive absolute capacitance signals onto sensor electrodes, and/or receiver circuitry configured to receive signals with those sensor electrodes. In one or more embodiments, a processing system for a combined mutual and absolute capacitance sensor device may include any combination of the above described mutual and absolute capacitance circuitry and/or circuitry for other types of sensing modalities such as strain gauges, resistive sensors, piezoelectric sensors, etc. In one or more embodiments, the processing system 120 also performs other functions, such as driving haptic actuators, etc.

In one or more embodiments, the processing system 120 includes electronically-readable instructions, such as firmware code, software code, and/or the like. The processing system 120 may include software configured to run on a central processing unit of the host system and one or more ICs (perhaps with associated firmware) separate from the central processing unit. As another example, the processing system 120 may include circuits and firmware that are part of a main processor of the computer system. In some embodiments, components composing the processing system 120 are located together, such as near sensing element(s) of the sensing system 130. In other embodiments, components of processing system 120 are physically separate with one or more components close to or couple to the sensing element(s) of the sensing system 130, and one or more components elsewhere.

The processing system 120 may be implemented as a set of modules that handle different functions of the processing system 120. Each module may include circuitry that is a part of the processing system 120, firmware, software, or a combination thereof. In various embodiments, different combinations of modules may be used. For example, as shown in FIG. 1, the processing system 120 may include a sensor module 121 and a determination module 122.

The determination module 122 may include functionality to determine whether a force is applied to the sensing system 130, determine position of the force, determine whether the input object 160 applies a touch in the dedicated sensing region 150, determine positional information of the input object 160, identify a gesture, determine an action to perform based on the gesture, a combination of gestures or other information, and/or perform other operations.

The sensor module 121 may include functionality to drive the touch sensor and the force sensor to transmit transmitter signals and receive the resulting signals. For example, the sensor module 121 may include sensory circuitry that is coupled to the sensing elements in the touch sensor and the force sensor. The sensor module 121 may include, for example, a transmitter module and a receiver module. The transmitter module may include transmitter circuitry that is coupled to a transmitting portion of the sensing elements. The receiver module may include receiver circuitry coupled to a receiving portion of the sensing elements and may include functionality to receive the resulting signals.

Although FIG. 1 shows only a determination module 122 and a sensor module 121, alternative or additional modules may exist in accordance with one or more embodiments of the disclosure. Example alternative or additional modules include hardware operation modules for operating hardware such as sensor electrodes, data processing modules for processing data such as sensor signals and positional information, reporting modules for reporting information, and identification modules configured to identify gestures, such as mode changing gestures, and mode changing modules for changing operation modes. Further, the various modules may be combined in separate integrated circuits. For example, a first module may be comprised at least partially within a first integrated circuit and a separate module may be comprised at least partially within a second integrated circuit. Further, portions of a single module may span multiple integrated circuits. In some embodiments, the processing system 120 as a whole may perform the operations of the various modules.

In some embodiments, the processing system 120 responds to user input (or lack of user input) in the dedicated sensing region 150 and abnormality directly by causing one or more actions. Example actions include changing operation modes, as well as graphical user interface (GUI) actions such as cursor movement, selection, menu navigation, and other functions. In some embodiments, the processing system 120 provides information about user input and/or abnormality to some part of the host system 170. In some embodiments, some part of the host system 170 processes information received from the processing system 120 to respond to user input and abnormality, such as to facilitate a full range of actions, including mode changing actions and GUI actions.

For example, in some embodiments, the processing system 120 operates the sensing element(s) of the sensing system 130 to produce electrical signals based on detected touch and/or force, indicative of user input and/or abnormality. The processing system 120 may perform any appropriate amount of processing on the electrical signals to produce the information provided to the host system 170. For example, the processing system 120 may digitize analog electrical signals obtained from the sensing system 130. As another example, the processing system 120 may perform filtering or other signal conditioning. As yet another example, the processing system 120 may subtract or otherwise account for a baseline, such that the information reflects a difference between the signals and the baseline. As yet further examples, the processing system 120 may determine positional information, recognize inputs as commands, recognize handwriting, and the like. “Position” or “location” as used herein broadly encompasses absolute position, relative position, velocity, acceleration, and other types of spatial information.

It should be understood that while many embodiments of the disclosure are described in the context of a fully functioning apparatus, the mechanisms of the present disclosure are capable of being distributed as a program product (e.g., software) in a variety of forms. For example, the mechanisms of the present disclosure may be implemented and distributed as a software program on information-bearing media that are readable by electronic processors (e.g., non-transitory computer-readable and/or recordable/writable information bearing media that is readable by the processing system or the host system).

While FIG. 1 shows a configuration of components, other configurations may be used without departing from the scope of the disclosure. For example, various components may be combined to create a single component. As another example, the functionality performed by a single component may be performed by two or more components.

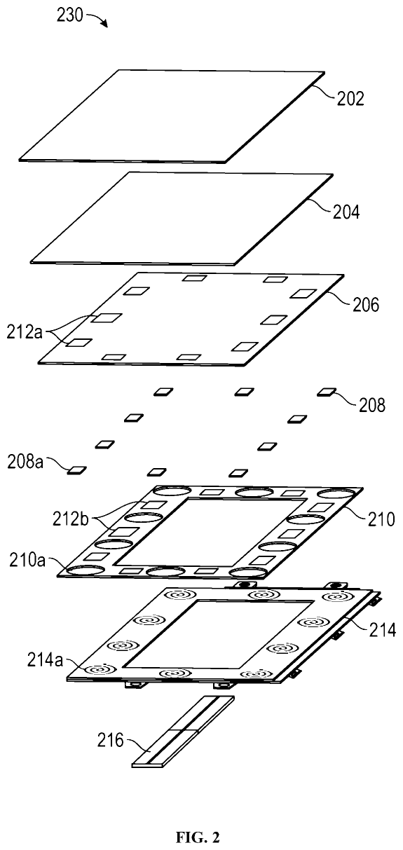

A sensing system in accordance with one or more embodiments of the present disclosure will now be described in a specific implementation shown in FIG. 2. While a configuration of touchpad is shown in FIG. 2, one having ordinary skill in the art would recognize that the present disclosure is not intended to be limiting and other implementations may be used without departing from the scope of the disclosure.

The sensing system 230, as shown in FIG. 2, includes a cover layer 202, an adhesive layer 204, a touch layer 206, a spacer layer 208, a flex layer 210, a force sensor 212, a baseplate 214, and a magnet 216.

In one or more embodiments, the cover layer 202 includes a relatively translucent or transparent substance capable of isolating circuitry in the sensing system from ambient objects. The cover layer 202 may be composed of, for example, glass, treated glass, plastic, diamond, sapphire, and other materials.

The adhesive layer 204 may be any type of adhesive that secures the touch layer 206 to the cover layer 202. While only one adhesive layer is shown in FIG. 2, it would be recognized to one having ordinary skill in the art that the sensing system may include a plurality of adhesive layers that couple the various layers or components of the sensing system together.

The touch layer 206 is configured to sense a touch of an input object and may function as the touch sensor or at least a part of the touch sensor described in one or more embodiments of the present disclosure, for example, in accordance with FIG. 1. In one or more embodiments, the touch layer 206 may include circuitry, such as a printed circuit board (PCB) or a printed circuit board assembly (PCBA), for detection of the input object, including determination of a position and/or a movement or gesture of the input object, in a dedicated sensing region. A projection of the dedicated sensing region may occupy a part or a whole of a surface of the touch layer 206 that is exposed to the input object. The dedicated sensing region may occupy a space above the surface of the touch layer 206.

The spacer layer 208 comprises one or more spacer components 208a, each comprising an inert material filling the space between the touch layer 206 and the baseplate 214. The spacer components 208a may be arranged in a variety of configurations, including linearly, in an array, or at irregular intervals. A number of the spacer components may be adjusted as needed and is not limited by the figure.

The flex layer 210 is configured to detect a flex, which may occur when the input object applies a pressure or applied force to the sensing system that is coupled with the touch of the input object. The flex layer 210 may be a flexible printed circuit (FPC), including photolithography metal on a flexible sheet such as a Polyethylene terephthalate (PET) material or lamination of metal traces within PET material. The flex layer 210 may have one or more cavities 210a, in the form of apertures or holes through the flex layer 210. In one or more embodiments, the position of the spacer components in the space layer 208 may correspond to the position of the cavities 210a in the flex layer 210. That is, the space components of the spacer layer 208 may accommodate in the cavities 210a of the flex layer 210.

The baseplate 214 is configured to prevent deformation of the sensing system and may be made of a rigid material such as metal. The baseplate 214 may be in direct contact with and is disposed at a (bottom) side of the flex layer 210, which is opposite to a side facing the touch layer 206. The flex layer 210 and the baseplate 214 may be coupled to each other using an adhesive. The baseplate 214 may be provided with a plurality of swirl-shape structures 214a, corresponding to the positions of the spacers in the spacer layer 208. Each of the spacers is disposed on each corresponding swirl-shape structure 214a. While swirl-shape structures are presented in the figure as an example, one having ordinary skill in the art would recognize that the shape is not limited by the figure, and that any other shape that allows deformation is applicable.

The force sensor 212 may include one or more force sensing units, each force sensing unit having a first capacitive sensing plate 212a and a second capacitive sensing plate 212b. The one or more first capacitive sensing plates 212a may be coupled to the touch layer 206, for example, attached to or embedded in a (bottom) surface of the touch layer 206 that faces the spacer layer 208. An adhesive may be used to immobilize the capacitive sensing plates 212a. A part of the flex layer 210, which corresponds to the positions of each of the first sensing plates 212a, may serve as the one or more second capacitive sensing plates 212b.

Under such a configuration, the first capacitive sensing plates 212a and the second capacitive sensing plates 212b are spaced apart facing each other in pairs, with a defined gap therebetween. Each force sensing unit, namely each pair of the first capacitive sensing plate and the second capacitive sensing plate, has a capacitive configuration, in which a capacitance between each pair of capacitive sensing plates is proportional to the distance between the pair of capacitive sensing plates.

In one or more embodiments, for example as shown in FIG. 2, the position of the swirl-shape structures 214a in the baseplate 214 may correspond to the position of the cavities 210a in the flex layer 210, which may also correspond to the spacer components 208a in the spacer layer 208. The first capacitive sensing plates on the touch layer and the second capacitive sensing plates on the base plate may be arranged at positions that do not overlap with the cavities in the flex layer or the swirl-shape structures in the baseplate. In other words, the spacer components 208a and the capacitive sensing plates 212a, 212b do not overlap, such that the spacer components are not inserted into the gap between each pair of the capacitive sensing plates.

When the input object applies a pressure or force to the sensing system that is coupled with the touch of the input object or when an abnormality occurs, a force is applied to the sensing system from its top or bottom. When such a force is applied, the swirl-shape structures 214a on the baseplate may deform, allowing the touch layer 208 to sink and move closer to the flex layer 210, thus causing a distance between each pair of first and second capacitive sensing plates to change. The force sensor 212 senses the capacitance that is related to the distance, or distance change. In one or more embodiments, the force sensor 212 includes more than one force sensing units at different locations, and the sensed results from the force sensing units may be used to determine a position of the abnormality.

In one or more embodiments, the sensing system may include at least one magnet 216. The magnet may be used for generation of haptic feedback of the sensing system. The haptic feedback may be generated in response to a touch from the input object or for any other reason, by simulating a click effect using the magnet 216. The magnet 216 may be attached to the baseplate 214, or may be embedded in a tray that is attached to baseplate 214.

During assembly of the computing system, the magnet in the sensing system may attract a ferromagnetic material, such as a screw, onto an outer periphery of the sensing system. Under such circumstances, the ferromagnetic material is an obstruction that may potentially cause abnormality to the sensing system and/or neighboring components, for example by causing damage or even puncture.

While only one configuration is shown in FIG. 2, one having ordinary skill in the art would recognize that the present disclosure is not intended to be limiting and other implementations may be used without departing from the scope of the disclosure. One or more components may be added, omitted, or modified. For example, the sensing system may include a protection layer coupled to the baseplate to an opposite side of the flex layer. One or more adhesive layers, tapes, or cartridges may be used to immobilize components of the sensing system. The sensing system may include cables or other conductive materials for transmission of signal and/or power. A number of force sensing units and an arrangement of the force sensing units may be modified based on configuration of the sensing system and arrangement of the spacer layer. The capacitive sensing plates may be coupled to other components in the sensing system, while a capacitive configuration is formed, and a distance may be measured.

While only one configuration of the touch mechanism is shown in FIG. 2, one having ordinary skill in the art would recognize that other touch mechanisms may also be used and that the force sensor disclosed herein may be applied to other touch mechanisms (e.g., capacitive, elastic, resistive, inductive, magnetic, acoustic, ultrasonic, piezoelectric, strain gauge-based, or optical).

In the non-limiting example shown in FIG. 2, the force sensor comprises first capacitive sensing plates and second capacitive sensing plates disposed on the touch layer and flex layer, respectively, and force sensing is performed based on the capacitance between the corresponding capacitive sensing plates whose distance between each other changes upon applied force. In other implementations, the force sensor may comprise first capacitive sensing plates and second capacitive sensing plates disposed on two opposite sides of the touch layer. A distance between the touch layer and the baseplate may be determined based on an electrical charge amount drained by the baseplate as a ground.

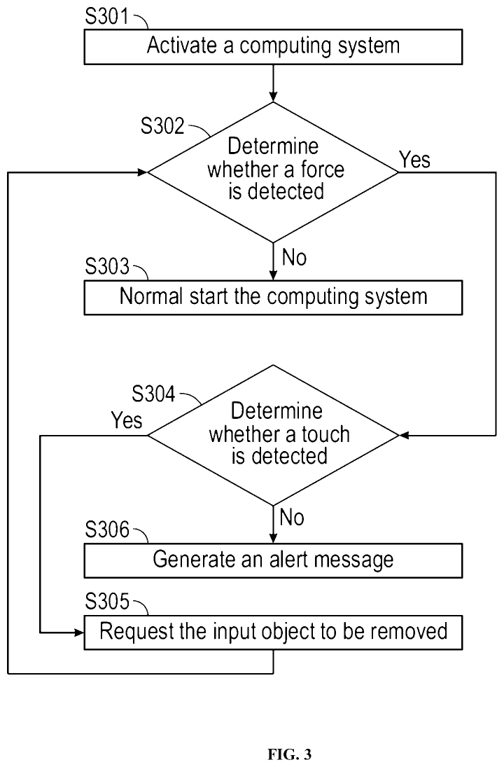

FIG. 3 shows a flowchart for a method of abnormality detection in accordance with one or more embodiments of the disclosure. While the various blocks in FIG. 3 are presented and described sequentially, one of ordinary skill in the art will appreciate that some or all of the blocks may be executed in different orders, may be combined or omitted, and some or all of the blocks may be executed in parallel. Furthermore, the blocks may be performed actively or passively.

The blocks in FIG. 3 may be performed by one or more components as described in FIGS. 1 and 2. For example, the sensing results may be obtained by the sensing system 130 described in one or more embodiments of the present disclosure. The sensing results may be transmitted to a processor to perform the functions in one or more blocks in FIG. 3. The sensing results may be processed in one or more processor(s), for example, a processor in the processing system 120, which operates the hardware of the sensing system 130, and/or a processor in the host system 170. One or more determinations in the blocks in FIG. 3 may be made based on the sensing results, which are subsequently used to instruct the operation of the computing system.

In step S301, the computing system is activated. The activation may be realized by, for example, turning on a power of the computing system. The computing system may be in an inactive state before step S301. The abnormality detection and determination described in one or more of the following steps may be a part of a power-on self-test (POST) of the computing system. POST is used by the computing system to check that basic system devices are present and working properly, for example, the keyboard and other peripheral devices, and hardware elements such as the processor and memory. In a case when the POST passes, the computing system will continue to bootup.

In step S302, a determination is made on whether force is applied to a sensing system in the computing system, using a force sensor in the sensing system. The force sensor may include two capacitive sensing plates in a capacitive configuration, facing each other and spaced-apart at a defined gap. When a force is applied, for example, to an outer periphery of the sensing system, a distance between two capacitive sensing plates may decrease, the capacitive sensing plates may move closer to each other, and the capacitance measured between the capacitive sensing plates may increase. Accordingly, such a change in capacitance may be correlated to the force that causes the change in the distance. In step S302, the measured capacitance and/or corresponding force may be compared with a predetermined base value. The predetermined base value may be obtained when no force is applied to the sensing system, for example, through a calibration process before assembling the sensing system into the computing system.

In one or more embodiments, when the measured capacitance and/or corresponding force and the predetermined base value are substantially the same, a determination may be made that an abnormality does not exist. Thus, the POST passes for the sensing system, and the computing system continues to a normal start S303, when an operating system is loaded such that the computing system is ready to take commands from the user. When the measured capacitance and/or corresponding force is different from the predetermined base value, a determination may be made that further determination based on detection results of a touch sensor is needed in step S304.

In one or more embodiments, the force sensor comprises a plurality of abnormality sensing units, each comprising a pair of capacitive sensing plates.

For each abnormality sensing unit, a capacitance is measured. The measured capacitance and/or corresponding force may be compared to the predetermined base value as described herein. The comparison result may indicate the position of the applied force, thus indicating the position of the abnormality. In one or more embodiments, the measured capacitance and/or corresponding force may be compared to each other to determine a position of the abnormality.

In step S304, a determination is made on whether an input object is applying a force to the sensing system, by sensing whether a touch of the input object is detected by a touch sensor in the sensing system. The touch sensor may utilize any combination of sensor components and sensing technologies for detecting a touch and may have features as described in one or more embodiments of the present disclosure.

In step S305, when it is determined that a touch of the input object is detected, the computing system requests the input object to be removed from the sensing system. A display of the computing system may show a message, requesting the input object to be removed from the sensing system, for example, a dedicated sensing region above the touch sensor. Once the input object is removed from the sensing system, another determination in step S302 is performed to determine whether the force still exists.

That is, when the touch sensor senses a touch of the input object in step S304, a determination is made that the input object might be applying a force to the sensing system. When such a determination is made, the computing system may request, via an alert message to the user, that the input object be removed from the sensing system in step S305. Then, another determination in step S302 is needed with the touch of the input object not detected. When the touch sensor does not sense a touch of the input object and the force sensor still detects a force, a determination is made that the detected force is caused by an abnormality.

In step S306, when a touch of the input object is not detected by the touch sensor and thus a determination is made that the force sensed by the force sensor is not caused by the input object, the computing system generates an alert message indicating that there is an abnormality in the computing system, or more specifically, to the sensing system. In one or more embodiments, the alert message is a Basic Input/Output System (BIOS) command. The computing system may determine that the POST does not pass for the sensing system, based on the generated alert message, and shut down the power of the computing system to avoid potential damage to the system.

The systems and methods described in the present disclosure have advantageous effects in abnormality detection, avoiding potential damage or danger. The abnormality may be caused by an obstruction to an outer periphery of the sensing system during assembly. For example, an obstruction may fall between the sensing system and the neighboring component during assembly of the sensing system, causing potential damage to the computing system or even danger to the user. The neighboring component may be any device of the computing system, depending on various configurations of the computing system. In some implementations, the neighboring component may be a battery, and an obstruction between the battery and the sensing system, such as a screw attracted to a magnet in the sensing system, may become dangerous, e.g., the obstruction may cause damage to the battery.

The abnormality may also be caused by a misfunction of the neighboring component. For example, a bulging battery disposed in proximity to the sensing system may apply a force to the sensing system, and the systems and methods in accordance with one or more embodiments described herein have the capability to sense such an abnormality.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

1. A computing system comprising:
a sensing system comprising:
a touch sensor configured to detect touch of an input object in a dedicated sensing region; and
a force sensor configured to detect force applied to the sensing system; and
a processor configured to determine abnormality based on detection results from the touch sensor and the force sensor.

2. The computing system according to claim 1, wherein the force sensor comprises a first capacitive sensing plate and a second capacitive sensing plate, and the force is detected based on a distance between the first capacitive sensing plate and the second capacitive sensing plate.

3. The computing system according to claim 1, wherein the force sensor comprises a plurality of force sensing units, each comprising a first capacitive sensing plate and a second capacitive sensing plate.

4. The computing system according to claim 3, wherein
the plurality of force sensing units each detect a sensed force, and
the processor determines a position of the abnormality based on the sensed forces detected by the plurality of force sensing units.

5. The computing system according to claim 1, wherein
the touch sensor comprises a touch layer, a baseplate, and a spacer layer between the touch layer and the baseplate,
the force sensor comprises a first capacitive sensing plate coupled to the touch layer and a second capacitive sensing plate coupled to the baseplate, and
the first capacitive sensing plate and the second capacitive sensing plate face each other and are spaced apart at a distance.

6. The computing system according to claim 1, wherein the processor is configured to compare the force detected by the force sensor to a predetermined base value.

7. The computing system according to claim 1, wherein the computing system performs a normal start, when the force detected by the force sensor is substantially same to a predetermined base value.

8. The computing system according to claim 1, wherein the computing system is configured to generate an alert message when the force detected by the force sensor is different from a predetermined base value and the touch of the input object is not detected by the touch sensor.

9. The computing system according to claim 1, wherein the computing system is configured to request the input object to be removed, when the force detected by the force sensor is different from a predetermined base value and the touch of the input object is detected by the touch sensor.

10. A method comprising:
activating a computing system;
detecting whether force is applied to a sensing system in the computing system, using a force sensor in the sensing system;
detecting whether touch of an input object occurred in a dedicated sensing region, using a touch sensor in the sensing system; and
determining abnormality based on detection results from the touch sensor and the force sensor.

11. The method of claim 10, further comprising comparing the force detected by the force sensor to a predetermined base value.

12. The method of claim 10, further comprising performing a normal start to the computing system, when the force detected by the force sensor is substantially same to a predetermined base value.

13. The method of claim 10, further comprising generating an alert message when the force detected by the force sensor is different from a predetermined base value and the touch of the input object is not detected by the touch sensor.

14. The method of claim 10, further comprising requesting the input object to be removed, when the force detected by the force sensor is different from a predetermined base value and the touch of the input object is detected by the touch sensor.

15. The method of claim 10, further comprising determining a position of the abnormality based on sensed forces detected by a plurality of force sensing units in the force sensor, each of the force sensing units comprising a first capacitive sensing plate and a second capacitive sensing plate.
